(19) United States
(12) Patent Application Publication
(10) Pub. No.: US 2013/0342420 A1
(43) Pub. Date: Dec. 26, 2013

(54) ANTENNA ASSEMBLY WITH MULTIBAND FUNCTION

(71) Applicant: Chi Mei Communication Systems, Inc., New Taipei (TW)

(72) Inventor: CHUN-YU LU, New Taipei (TW)

(21) Appl. No.: 13/911,341

(22) Filed: Jun. 6, 2013

(30) Foreign Application Priority Data
Jun. 26, 2012 (TW) 101122735

(51) Int. Cl. H01Q 5/01

(52) U.S. Cl. CPC H01Q 5/01
USPC 343/850

(57) ABSTRACT

A simple antenna assembly suitable for several wireless frequency bands includes a base board, a first radiator, and a second radiator. The base board has opposite sides connected by an edge and includes a feed point and a grounding point. The first radiator is electronically connected to the feed point, and the second radiator is electronically connected to the grounding point. The first radiator and the second radiator are positioned at opposite sides of an edge of the base board and spaced from each other. The first radiator receives and transmits wireless signals having a first central frequency, and the second radiator is coupled with the first radiator to cooperatively receive and transmit wireless signals having a second central frequency.

### BACKGROUND

1. Technical Field

The present disclosure relates to antenna assemblies, and particularly to an antenna assembly for a wireless communication device.

2. Description of Related Art

Antennas are found in mobile phones for example. Commonly, a wireless communication device may receive/transmit wireless signals having different frequencies, requiring the presence of a multiband antenna. However, many multiband antennas have complicated structures and are large in size, making it difficult to miniaturize wireless electronic devices.

Therefore, there is room for improvement within the art.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a schematic view of an antenna assembly, according to a first exemplary embodiment.

FIG. 2 is a return loss (RL) graph of the antenna assembly shown in FIG. 1.

FIG. 3 is a schematic view of an antenna assembly, according to a second exemplary embodiment.

FIG. 4 is a RL graph of the antenna assembly shown in FIG. 3.

### DETAILED DESCRIPTION

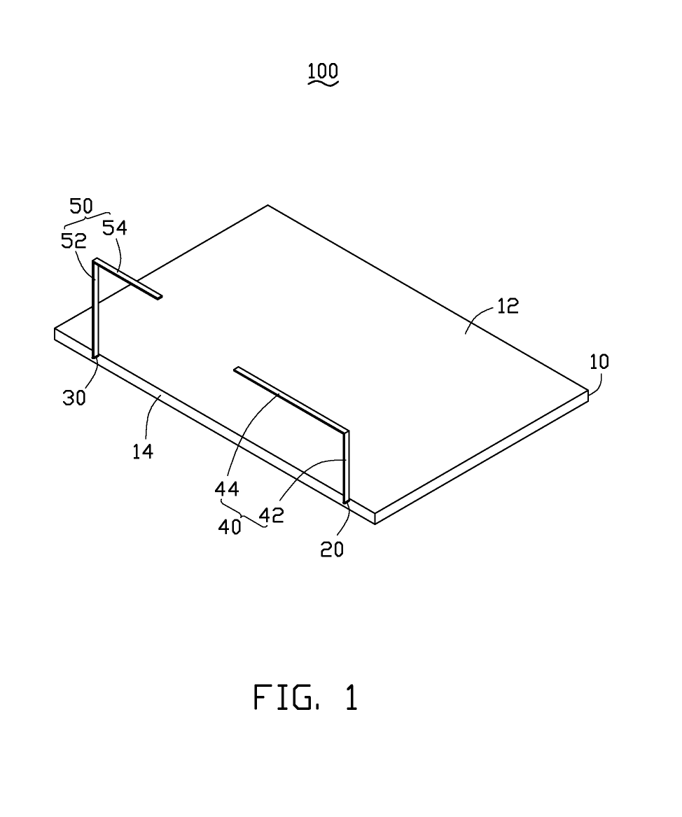

FIG. 1 shows an antenna assembly 100, according to a first exemplary embodiment. The antenna assembly 100 is employed in a wireless communication device (not labeled). The wireless communication device may be a mobile phone or a personal digital assistant, for example.

The antenna assembly 100 includes a base board 10, a first radiator 40, and a second radiator 50. The first radiator 40 and the second radiator 50 are mounted on the base board 10, and are opposite to and spaced from each other.

In the exemplary embodiment, the base board 10 is a printed circuit board (PCB) of the wireless communication device, and is made of composite materials. The base board 10 is substantially a rectangular board having a top surface 12 and an edge surface 14 perpendicularly connected to the top surface 12. A feed point 20 and a grounding point 30 are separately located at the edge surface 14. The feed point 20 feeds current into the antenna assembly 100, and the antenna assembly 100 connects to ground via the grounding point 30.

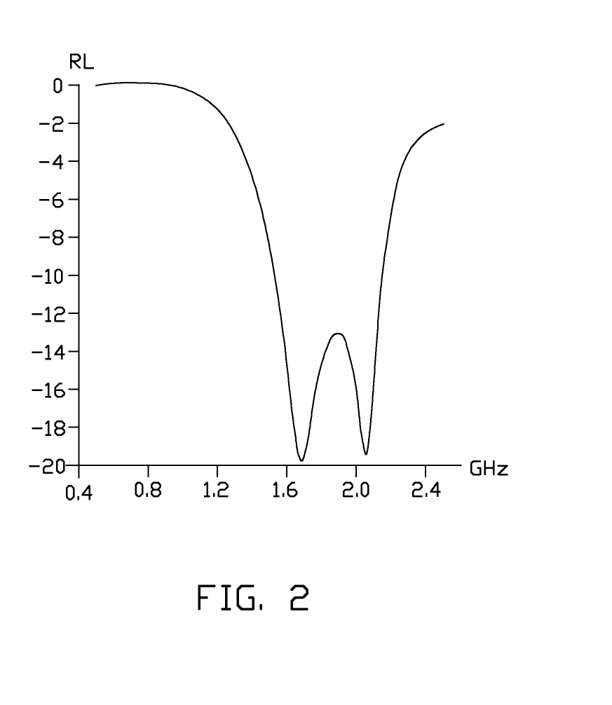

In the exemplary embodiment, the first radiator 40 is a bent L-shaped bar of metal. The first radiator 40 includes a first connection section 42 and a second connection section 44. The first connection section 42 is perpendicularly connected to the feed point 20. The second connection section 44 is perpendicularly connected to the first connection section 42, and is parallel to the top surface 12. Referring to FIG. 2, the first radiator 40 receives and transmits wireless signals having a first central frequency of about 2100 MHz (such as WCDMA 2100).

In the exemplary embodiment, the second radiator 50 is a bent L-shaped bar of metal. The second radiator 50 includes a first radio section 52 and a second radio section 54. The first radio section 52 is perpendicularly connected to the grounding point 30, and is parallel to the first connection section 42. The second radio section 54 is perpendicularly connected to the first radio section 52, and extends towards the second connection section 44 and is parallel to the top surface 12. In the exemplary embodiment, a length of the first radio section 52 is greater than a length of the first connection section 42, a length of the second radio section 54 is less than a length of the second connection section 44, and the second radio section 54 does not pass a distal end of second connection section 44. Thus, the second radio section 54 is set above the second connection section 44, and orthographic projections of the second radio section 54 and the second connection section 44 on the top surface 12 shows no overlap with each other. Referring to FIG. 2, the second radiator 50 can couple with the first radiator 40 to receive and transmit wireless signals having a second central frequency of about 1800 MHz (such as GSM 1800).

When current is input to the antenna assembly 100 from the feed point 20 and travels through the first radiator 40, the first radiator 40 serves as a monopole antenna to receive wireless signals having the first central frequency. The second radiator 50 is coupled with the first radiator 40, and a circuit is formed from the feed point 20 to the grounding point 30 through the first radiator 40 and the second radiator 50. Thus, the first radiator 40 and the second radiator 50 cooperatively receive wireless signals having the second central frequency. In this way, the antenna assembly 100 serves as a dual-band antenna.

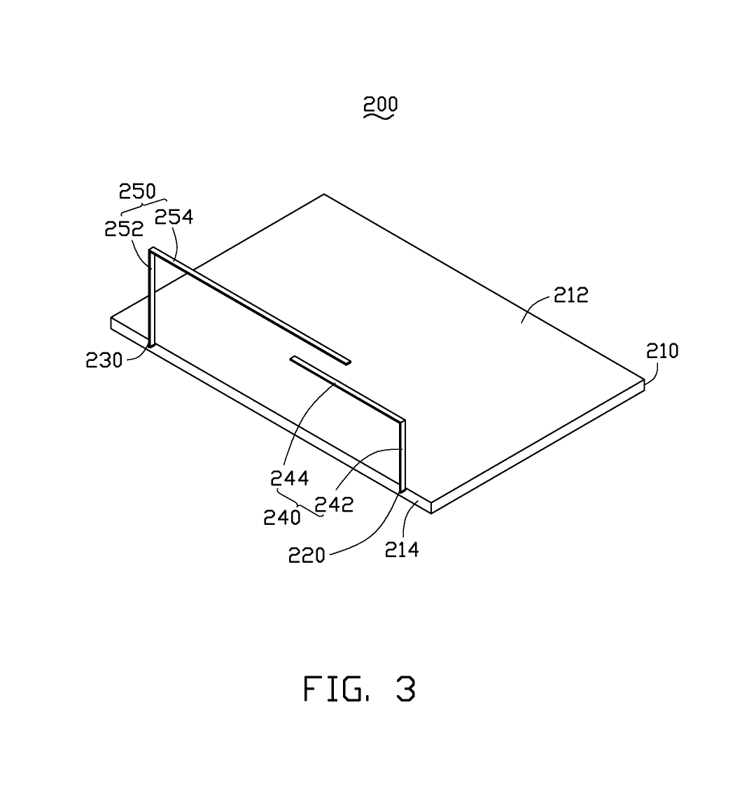

FIG. 3 shows an antenna assembly 200 including a base board 210, a first radiator 240, and a second radiator 250. The base board 210 includes a top surface 212 and an edge surface 214. A feed point 220 and a grounding point 230 are separately located at the edge surface 214. The first radiator 240 includes a first connection section 242 and a second connection section 244 perpendicularly connected to the first connection section 242. The first connection section 242 is perpendicularly connected to the feed point 220. The second radiator 250 includes a first radio section 252 and a second radio section 254 perpendicularly connected to the first radio section 252. The first radio section 252 is perpendicularly connected to the grounding point 230.

In the second exemplary embodiment, the length of the second radio section 254 is greater than the length of the second connection section 244, and the second radio section 254 passes a distal end of the second connection section 244. Thus, orthographic projections of the second radio section 254 and the second connection section 244 on the top surface 212 would show a partial overlap with each other.

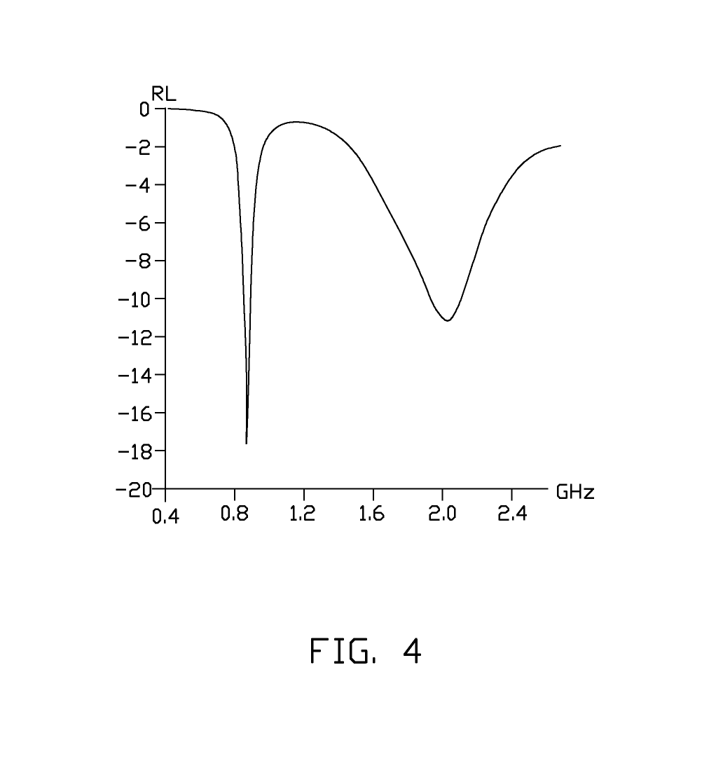

Referring to FIG. 4, when the antenna assembly 200 receives/transmits wireless signals at frequencies of about 1710-2170 MHz, and 824-960 MHz, the return loss (RL) of the antenna assembly 200 is less than −6 dB, and satisfies communication standards. Accordingly, the wireless communication device employing the antenna assembly 200 can be used in a plurality of (more than two) common wireless communication systems, such as GSM850/900, GSM1800/1900, WCDMA-V, and WCDMA-VIII, with acceptable communication quality.

In summary, the antenna assembly 100/200 uses the first radiator 40/240 to receive and transmit wireless signals having the first central frequency and uses the first radiator 40/240 and the second radiator 50/250 cooperatively to receive and transmit wireless signals having the second central frequency. Thus, the antenna assembly 100/200 can receive and transmit wireless signals in two wireless frequency bands. Moreover, the first radiator 40/240 and the second radiator 50/250 are mounted on an edge of a base board 10/210, and do not occupy much space. Thus, the antenna assembly 100/200 is small in size and has good communication quality at a plurality of frequency bands used in wireless communications, which allows further size reductions of the wireless communication device employing the antenna assembly 100/200.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An antenna assembly, comprising:
a base board having opposite sides connected by an edge and comprising a feed point and a grounding point;
a first radiator electronically connected to the feed point; and
a second radiator electronically connected to the grounding point;
wherein the first radiator and the second radiator are positioned at opposite sides of an edge of the base board and spaced from each other, the first radiator receives and transmits wireless signals having a first central frequency, and the second radiator is coupled with the first radiator to cooperatively receive and transmit wireless signals having a second central frequency.

2. The antenna assembly as claimed in claim 1, wherein the base board includes a top surface and the edge surface perpendicularly connected to the top surface, the feed point and the grounding point are separately located at the edge surface.

3. The antenna assembly as claimed in claim 2, wherein the first radiator includes a first connection section and a second connection section, the first connection section is perpendicularly connected to the feed point, the second connection section is perpendicularly connected to the first connection section, and is parallel to the top surface.

4. The antenna assembly as claimed in claim 3, wherein the second radiator includes a first radio section and a second radio section, the first radio section is perpendicularly connected to the grounding point, the second radio section is perpendicularly connected to the first radio section, and is parallel to the top surface.

5. The antenna assembly as claimed in claim 4, wherein a length of the first radio section is greater than a length of the first connection section, and a length of the second radio section is less than a length of the second connection section.

6. The antenna assembly as claimed in claim 5, wherein the second radio section is set above the second connection section, the second radio section does not pass a distal end of second connection section, and orthographic projections of the second radio section and the second connection section on the top surface shows no overlap with each other.

7. The antenna assembly as claimed in claim 4, wherein a length of the second radio section is greater than the length of the second connection section, and the second radio section passes a distal end of the second connection section.

8. The antenna assembly as claimed in claim 4, wherein orthographic projections of the second radio section and the second connection section on the top surface partially overlap with each other.

9. An antenna assembly, comprising:
a base board having opposite sides connected by an edge and comprising a feed point and a grounding point;
a first radiator comprising a first connection section and a second connection section, the first connection section electronically connected to the feed point, and the second connection section perpendicularly connected to the first connection section; and
a second radiator comprising a first radio section and a second radio section, the first radio section electronically connected to the grounding point, and the second radio section perpendicularly connected to the first radio section;
wherein the first connection section is parallel to the first radio section, the second connection section and the second radio section are positioned at opposite sides of an edge of the base board and spaced from each other.

10. The antenna assembly as claimed in claim 9, wherein a length of the first radio section is greater than a length of the first connection section, and a length of the second radio section is less than a length of the second connection section.

11. The antenna assembly as claimed in claim 10, wherein the second radio section is set above the second connection section, the second radio section does not pass a distal end of second connection section, and orthographic projections of the second radio section and the second connection section on the base board shows no overlap with each other.

12. The antenna assembly as claimed in claim 9, wherein a length of the second radio section is greater than the length of the second connection section, and the second radio section passes a distal end of the second connection section.

13. The antenna assembly as claimed in claim 12, wherein orthographic projections of the second radio section and the second connection section on the base board partially overlap with each other.
